(19) United States
(12) Patent Application Publication
(10) Pub. No.: US 2019/0180255 A1
(43) Pub. Date: Jun. 13, 2019

(54) UTILIZING MACHINE LEARNING TO GENERATE RECOMMENDATIONS FOR A TRANSACTION BASED ON LOYALTY CREDITS AND STORED-VALUE CARDS

(71) Applicant: Capital One Services, LLC, McLean, VA (US)

(72) Inventors: Amit Deshpande, McKinney, TX (US); Satish Chikkaveerappa, McKinney, TX (US); Mithra Kosur Venuraju, Frisco, TX (US)

(21) Appl. No.: 15/839,374

(22) Filed: Dec. 12, 2017

(51) Int. Cl. G06Q 20/10; G06Q 20/32; G06Q 30/02; G06Q 30/06; G06Q 30/04; G06Q 40/02; G06N 3/02; G06F 15/18

(52) U.S. Cl. CPC G06Q 20/102; G06Q 20/322; G06Q 30/0229; G06Q 30/0631; G06F 15/18; G06Q 30/06; G06Q 40/025; G06N 3/02; G06Q 30/04

(57) ABSTRACT

A device receives a first set of information that relates to bank accounts associated with users, and receives a second set of information that relates to loyalty credits associated with the users. The device receives a third set of information that relates to stored-value cards associated with the users, and trains a model based on the first, second, and third sets of information. The device receives, from a client device, a request for a transaction, and utilizes the trained model to generate recommendations. The device provides, to the client device, the recommendations and a request for transaction information, and receives, from the client device, the transaction information, where the transaction information includes account information, loyalty credits information, and stored-value card information. The device determines transaction terms based on the account information, the loyalty credits information, and the stored-value card information, and provides the transaction terms to the client device.

### BACKGROUND

Consumers perform many transactions, such as applying for a vehicle loan, a mortgage loan, a payday loan, an appliance loan, a home equity loan, a student loan, a personal loan, a small business loan, and/or the like. When performing such transactions, a consumer applies for the loan with an entity (e.g., a bank, a credit union, a mortgage company, a vehicle financing company, and/or the like), and the entity checks a credit score of the consumer. The credit score is based on information in the consumer's credit report, and the credit report includes information about each account that the consumer has established with lenders. The information about each account includes information indicating a type of account (e.g. a bank card, an automotive loan, a mortgage, and/or the like), date the account was established, a credit limit, a loan amount, an account balance, a payment history, and/or the like.

The entity utilizes the credit score to determine a loan rate and a loan term for the loan, and prequalifies the consumer for the loan rate and the loan term. A consumer with a higher credit score will prequalify for a better loan rate and loan term than a loan rate and loan term allocated to a consumer with a lower credit score.

### SUMMARY

According to some implementations, a device may include one or more memories, and one or more processors, communicatively coupled to the one or more memories, to receive a first set of information from a first group of servers, where the first set of information relates to bank accounts associated with a plurality of users. The one or more processors may receive a second set of information from a second group of servers, where the second set of information relates to loyalty credits associated with the plurality of users, and may receive a third set of information from a third group of servers, where the third set of information relates to stored-value cards associated with the plurality of users. The one or more processors may train a model based on the first set of information, the second set of information, and the third set of information, and may receive, from a client device associated with a user, a request for a transaction. The one or more processors may utilize the trained model to generate one or more recommendations associated with the transaction, and may provide, to the client device, the one or more recommendations and a request for transaction information associated with the user. The one or more processors may receive, from the client device, the transaction information based on the request for the transaction information, where the transaction information includes account information associated with a bank account of the user, loyalty credits information identifying loyalty credits associated with the user, and stored-value card information identifying a stored-value card associated with the user. The one or more processors may determine transaction terms for the transaction based on the account information, the loyalty credits information, and the stored-value card information, and may provide information identifying the transaction terms to the client device.

According to some implementations, a non-transitory computer-readable medium may store instructions that include one or more instructions that, when executed by one or more processors, cause the one or more processors to receive a first set of information from a first group of servers, where the first set of information relates to bank accounts associated with a plurality of users, and receive a second set of information from a second group of servers, where the second set of information relates to loyalty credits associated with the plurality of users. The one or more instructions may cause the one or more processors to receive a third set of information from a third group of servers, where the third set of information relates to stored-value cards associated with the plurality of users, and train a model based on the first set of information, the second set of information, and the third set of information. The one or more instructions may cause the one or more processors to receive, from a client device associated with a user, a request for a transaction, and utilize the trained model to generate one or more recommendations associated with the transaction. The one or more instructions may cause the one or more processors to provide, to the client device, the one or more recommendations and a request for transaction information associated with the user, and receive, from the client device, the transaction information based on the one or more recommendations and based on the request for the transaction information, where the transaction information includes account information associated with a bank account of the user, and loyalty credits information identifying loyalty credits associated with the user. The one or more instructions may cause the one or more processors to determine transaction terms for the transaction based on the account information and the loyalty credits information, and provide information identifying the transaction terms to the client device.

According to some implementations, a method may include receiving, by a device, a first set of information from a first group of servers, where the first set of information relates to bank accounts associated with a plurality of users, and receiving, by the device, a second set of information from a second group of servers, where the second set of information relates to loyalty credits associated with the plurality of users. The method may include receiving, by the device, a third set of information from a third group of servers, where the third set of information relates to stored-value cards associated with the plurality of users, and training, by the device, a model based on the first set of information, the second set of information, and the third set of information. The method may include receiving, by the device and from a client device associated with a user, a request for a transaction, and utilizing, by the device, the trained model to generate one or more recommendations associated with the transaction and the user. The method may include providing, by the device and to the client device, the one or more recommendations, and obtaining, by the device and based on the one or more recommendations, account information associated with a bank account of the user. The method may include obtaining, by the device and based on the one or more recommendations, loyalty credits information identifying loyalty credits associated with the user, and obtaining, by the device and based on the one or more recommendations, stored-value card information identifying a stored-value card associated with the user. The method may include determining, by the device, transaction terms for the transaction based on the account information and at least one of the loyalty credits information or the stored-value card information, and providing, by the device, information identifying the transaction terms to the client device.

### BRIEF DESCRIPTION OF THE DRAWINGS

FIGS. 1A-1H are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for utilizing machine learning to generate recommendations for a transaction based on loyalty credits and stored-value cards.

### DETAILED DESCRIPTION

The following detailed description of example implementations refers to the accompanying drawings. The same reference numbers in different drawings may identify the same or similar elements.

Consumers today own assets that would improve their credit scores, but those assets are not considered when calculating their credit scores. For example, consumers can own loyalty credits associated with credit cards, debit cards, loyalty cards, rewards cards, points cards, advantage cards, club cards, and/or the like that identify the card holders as participants in loyalty programs (e.g., programs that encourage consumers to continue to shop at or use services of businesses associated with each program). In another example, consumers can own stored-value cards (e.g., gift cards, calling cards, fare cards, and/or the like) that include monetary values stored on the cards rather than in an external account maintained by a financial institution, and may be anonymous (e.g., not issued in the names of the consumers). However, such assets are not considered by entities when prequalifying consumers for loans, resulting in poorer loan rates and terms for consumers. Furthermore, such assets cannot be utilized to satisfy or reduce terms of a loan, such as a down payment, processing fees, tax fees, and/or the like.

Some implementations described herein provide a transaction platform that utilizes machine learning to generate recommendations and better terms for a transaction based on loyalty credits and stored-value cards. For example, the transaction platform may train a model based on information that relates to bank accounts associated with users, information that relates to loyalty credits associated with the users, and information that relates to stored-value cards associated with the users. The transaction platform may utilize the trained model to generate recommendations associated with a transaction requested by a consumer, and may provide the recommendations to the consumer. The transaction platform may receive account information associated with a bank account of the consumer, loyalty credits information identifying loyalty credits associated with the consumer, and stored-value card information identifying a stored-value card associated with the consumer. The transaction platform may determine transaction terms for the transaction based on the account information, the loyalty credits information, and the stored-value card information, and may provide information identifying the transaction terms to the consumer.

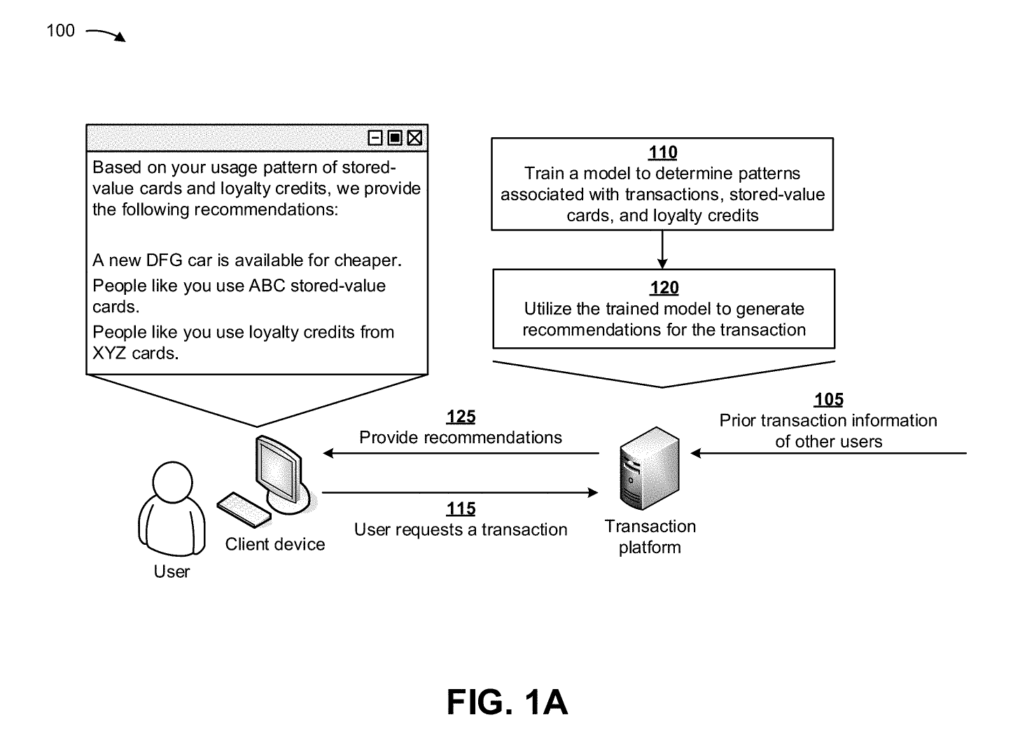

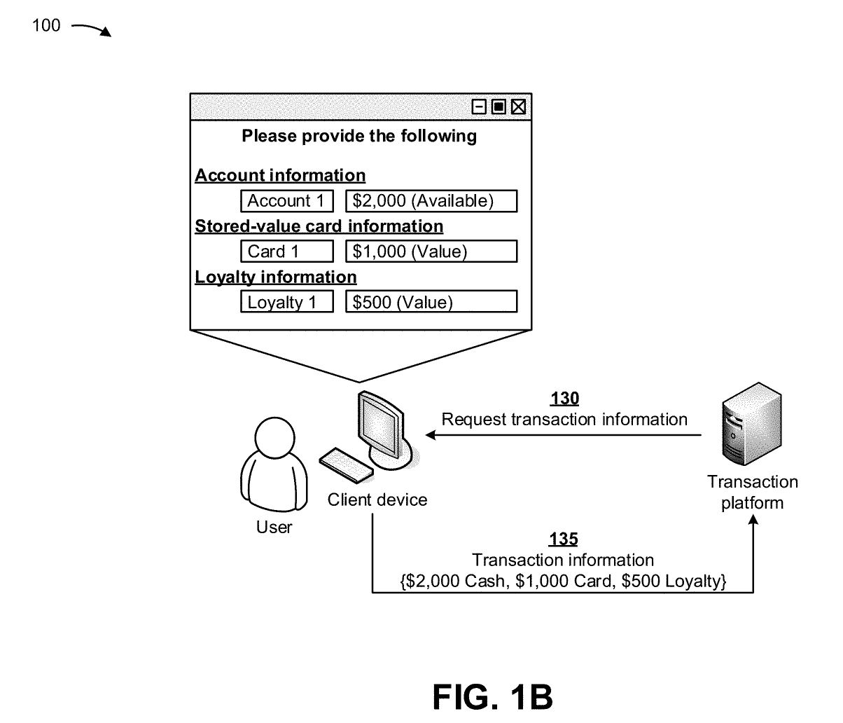

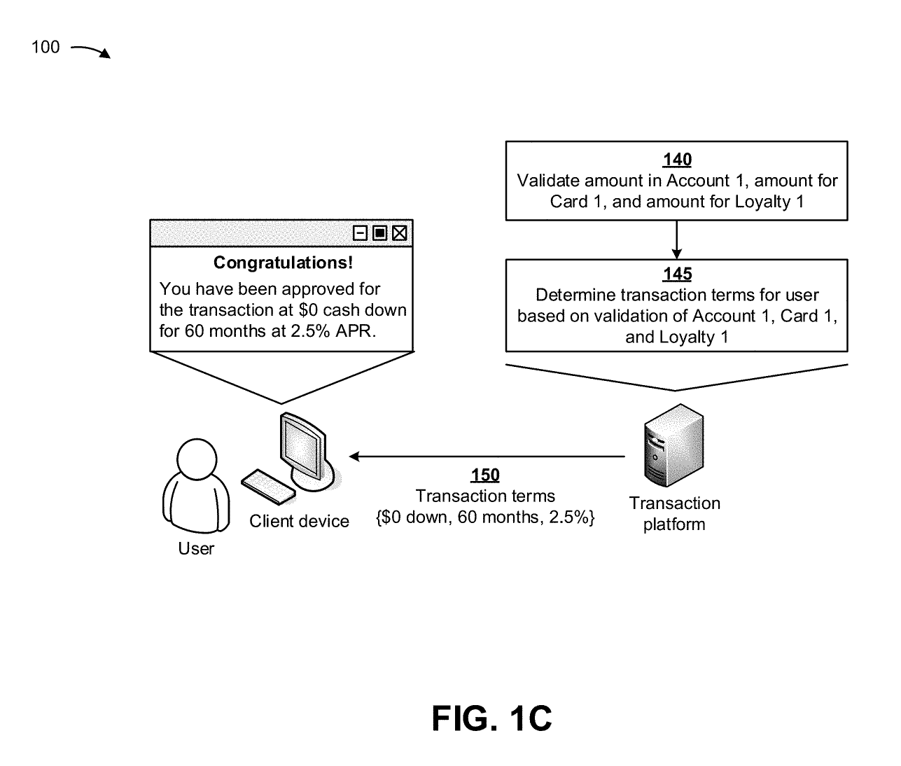

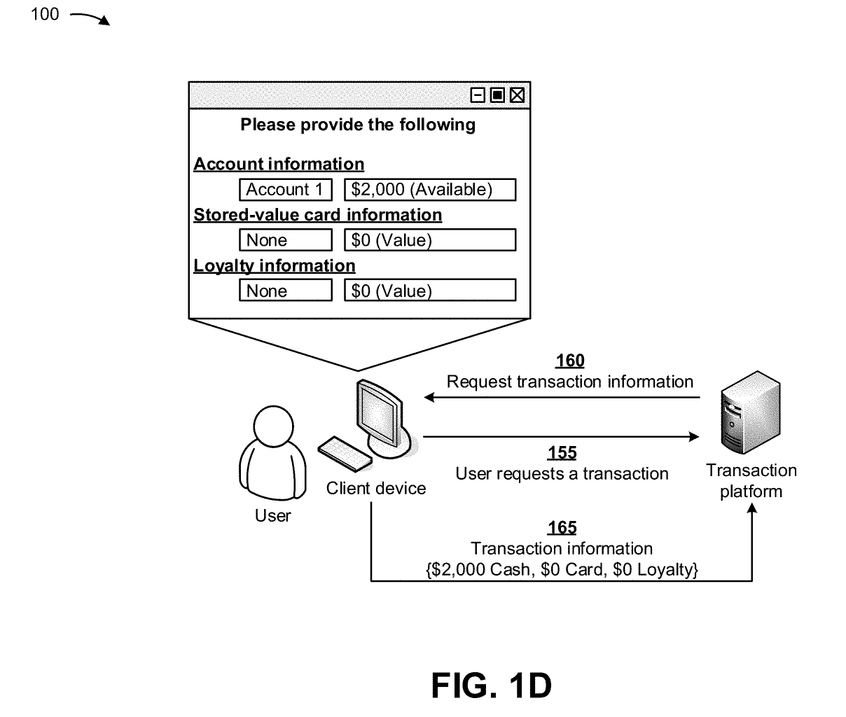

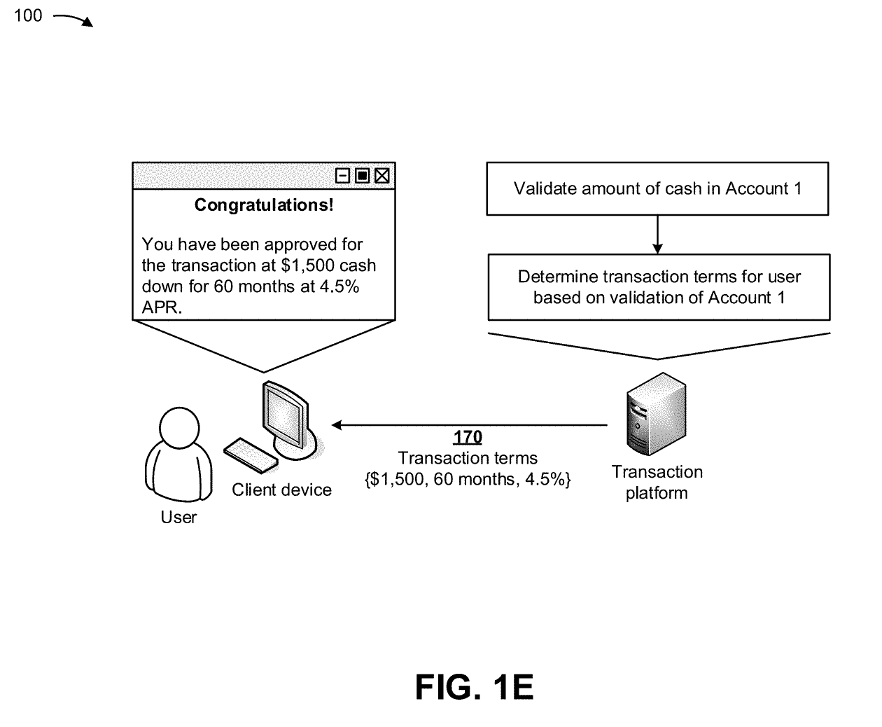

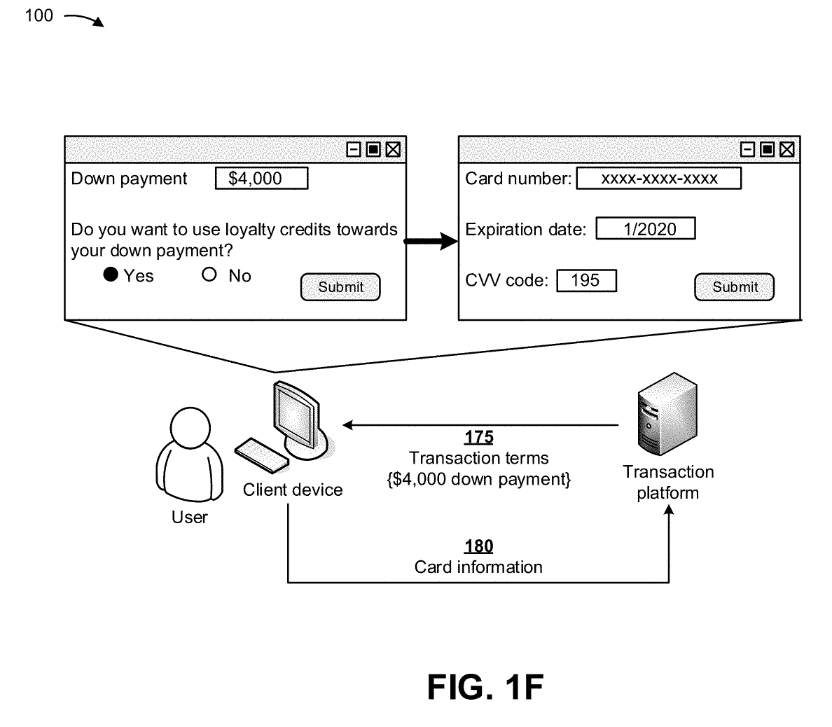

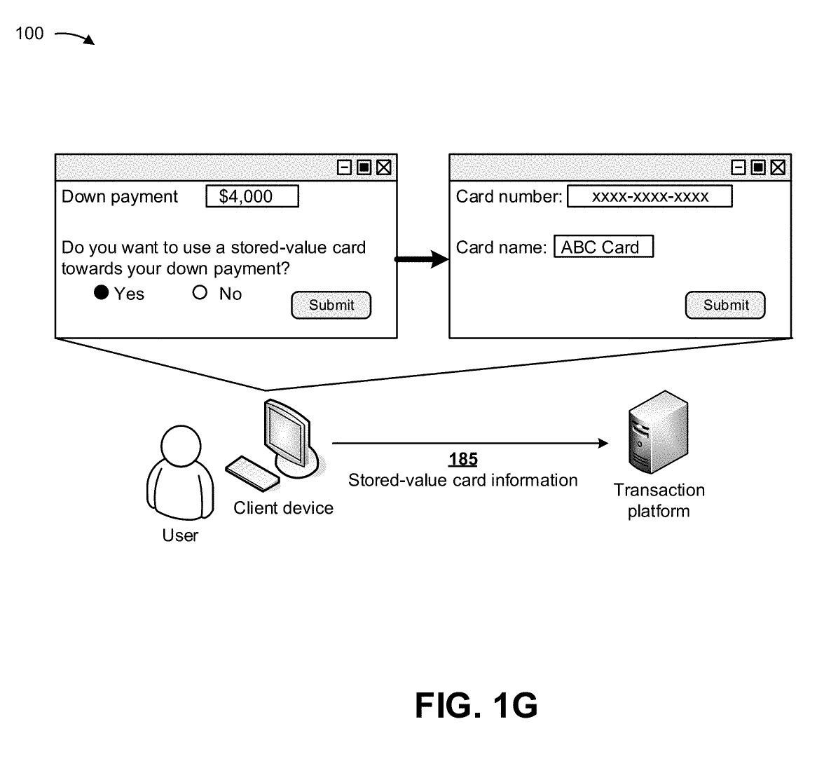

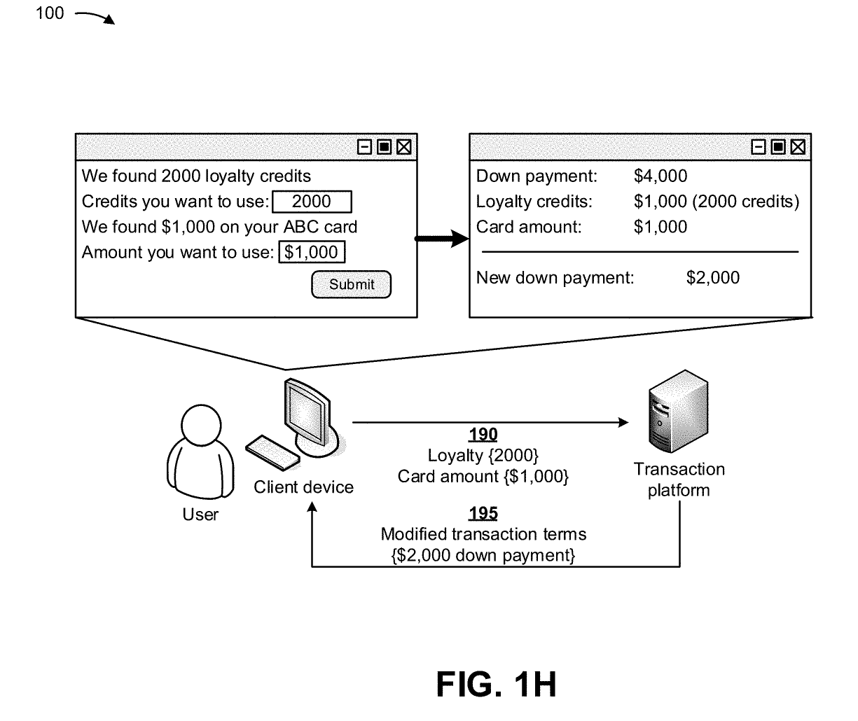

FIGS. 1A-1H are diagrams of an overview of an example implementation 100 described herein. As shown in FIG. 1A, a client device may be associated with a user and a transaction platform. As shown in FIG. 1A, and by reference number 105, the transaction platform may receive prior transaction information of other users. In some implementations, the prior transaction information may include information associated with prior transactions of other users, such as applications for loans (e.g., vehicle loans, mortgage loans, payday loans, appliance loans, home equity loans, student loans, personal loans, small business loans, and/or the like) by the other users, purchases of products, services, products and services, and/or the like by the other users, and/or the like. In some implementations, the prior transaction information may include information associated with accounts utilized by the other users for the prior transactions, such as bank accounts, credit card accounts, debit card accounts, and/or the like of the other users. In some implementations, the prior transaction information may include information associated with loyalty credits of the other users or utilized by the other users for the prior transactions. In some implementations, the prior transaction information may include information associated with stored-value cards of the other users or utilized by the other users for the prior transactions.

In some implementations, the prior transaction information may be provided in a particular format, such as a spreadsheet format that includes the prior transaction information, a table that includes the prior transaction information, and/or the like. In some implementations, the transaction platform may automatically retrieve the prior transaction information from other devices (e.g., devices associated with the other users, devices associated with providing loans, devices associated with selling products and/or services, devices associated with accounts of the other users, devices associated with the loyalty credits of the other users, devices associated with the stored-value cards of the other users, and/or the like).

In some implementations, the transaction platform may receive the prior transaction information, and may store the prior transaction information in a data structure, such as a database, a table, a linked-list, a tree, and/or the like. In some implementations, the data structure may be provided in a memory associated with the transaction platform. The transaction platform may store the prior transaction information so that the transaction platform may perform further processing on the prior transaction information. In some implementations, the transaction platform may provide security features so that prior transaction information is maintained in confidence.

As further shown in FIG. 1A, and by reference number 110, the transaction platform may train a model to determine patterns associated with the prior transactions, the stored-value cards, and the loyalty credits associated with the other users. In some implementations, the model may include a collaborative filtering model, an artificial intelligence model, a machine learning model, a naïve Bayes biased classifier model, a deep learning neural network model, a neural network model, a support vector machine model, and/or the like. In some implementations, the transaction platform may process the prior transaction information using natural language processing. In this case, the model may include or be associated with a natural language processing application that recognizes, parses, and/or interprets the prior transaction information. Natural language processing is a field of computer science, artificial intelligence, and/or computational linguistics concerned with the interactions between computers and human (natural) languages and, in some cases, may be particularly concerned with programming computers to fruitfully process large natural language corpora.

As further shown in FIG. 1A, and by reference number 115, the user may utilize the client device to request a transaction, and the client device may provide the request for the transaction to the transaction platform. For example, the user may request a vehicle loan to purchase a new car from a car dealer. The transaction platform may receive the request for the transaction. In some implementations, the request may include information associated with the new car (e.g., the price of the new car, a depreciable life associated with the new car, a warranty for the new car, and/or the like), information associated with accounts of the user (e.g., bank accounts, credit card accounts, debit card accounts, and/or the like), information associated with loyalty credits of the user, information associated with stored-value cards of the user, and/or the like. In some implementations, the transaction platform may receive the information associated with accounts of the user, the information associated with loyalty credits of the user, and the information associated with stored-value cards of the user prior to generation of the request for the transaction (e.g., via the prior transaction information or via a separate interaction with the client device).

As further shown in FIG. 1A, and by reference number 120, the transaction platform may utilize the trained model to generate recommendations for the transaction. In some implementations, the transaction platform may utilize the information included the request with the trained model in order to determine similarities between the prior transaction information and the request for the transaction, and to generate the recommendations based on the similarities. For example, the model may determine that the new car sought by the user (e.g., a new DFG car) is available at another car dealer for a cheaper price, may determine that other people like the user utilize a particular stored-value card (e.g., an ABC stored-value card) when applying for a car loan, may determine that other people like the user utilize loyalty credits from a particular loyalty card (e.g., an XYZ loyalty card), and/or the like. As shown by reference number 125, the transaction platform may provide the recommendations to the client device, and the client device may provide the recommendations for display to the user. In some implementations, the user may utilize one or more of the recommendations for the transaction, or may not utilize the recommendations for the transaction.

As shown in FIG. 1B, and by reference number 130, the transaction platform may request transaction information from the client device. In some implementations, the transaction platform may request transaction information that was not provided via the request for the transaction. For example, the transaction platform may request account information associated with the user, stored-value card information associated with the user, loyalty information associated with the user, and/or the like. In some implementations, the account information may include information associated with accounts to be utilized by the user for the transaction, such as bank accounts, credit card accounts, debit card accounts, and/or the like of the user. In some implementations, the stored-value card information may include information associated with stored-value cards to be utilized by the user for the transaction. In some implementations, the loyalty information may include information associated with loyalty credits to be utilized by the user for the transaction. For example, the user may indicate (e.g., via inputting information) that the user wishes to utilize a particular account (e.g., Account 1 with $2,000 of cash available), a particular stored-value card (e.g., Card 1 with a value of $1,000), and a particular loyalty program (e.g., Loyalty 1 with a value of $500) for the new car loan.

As further shown in FIG. 1B, and by reference number 135, the user may cause the client device to provide the transaction information (e.g., $2,000 cash from the particular account, $1,000 from the particular stored-value card, and $500 from the particular loyalty program) to the transaction platform. The transaction platform may receive the transaction information. In some implementations, rather than requesting the transaction information, the transaction platform may automatically select one or more accounts of the user, one or more loyalty credits of the user, and/or one or more stored-value cards of the user that will provide the most value for the user (e.g., that will ensure that the user receives the best terms for the new car loan).

As shown in FIG. 1C, and by reference number 140, the transaction platform may validate the transaction information (e.g., the account information associated with the user, the stored-value card information associated with the user, the loyalty information associated with the user, and/or the like). In some implementations, the transaction platform may validate the quantities of cash in the accounts (e.g., Account 1) of the user by querying devices associated with the accounts (e.g., devices associated with banks, credit card companies, debit card companies, and/or the like) of the user, and verifying that the quantities of cash in the accounts are correct. In some implementations, the transaction platform may validate the quantities of cash on the stored-value cards (e.g., Card 1) of the user by querying devices associated with the stored-value cards (e.g., devices associated with gift cards, calling cards, and/or the like) of the user, and verifying that the quantities of cash on the stored-value cards are correct. In some implementations, the transaction platform may validate cash values of the loyalty credits (e.g., Loyalty 1) of the user by querying devices associated with the loyalty credits (e.g., devices associated with loyalty cards, rewards cards, points cards, advantage cards, club cards, and/or the like) of the user, and verifying that the cash values of the loyalty credits are correct. In some implementations, if any of the transaction information is incorrect, the transaction platform may automatically adjust the transaction information to a verified value, may automatically disregard the incorrect transaction information, may provide the incorrect transaction information to the client device (e.g., and may ask the user to provide correct transaction information), and/or the like.

In some implementations, the transaction platform may update the model based on the transaction information. For example, the transaction platform may update the model based on the stored-value card information associated with the user, the loyalty information associated with the user, and/or the like. In some implementations, the transaction platform may utilize the transaction information to identify preferences of the user. For example, the transaction platform may identify preferences associated with a bank account, credit card account, debit card account, loyalty program, stored-value card, and/or the like, associated with the user. In some implementations, the preferences may influence the recommendations output by the model, may override the recommendations output by the model, may be used in combination with the recommendations output by the model, and/or the like. In some implementations, the transaction platform may identify preferences associated with providers (e.g., of loyalty programs, stored-value cards, payment cards, and/or the like), financial institutions (e.g., banks, credit card companies, and/or the like), sellers of products and/or services (e.g., to accept and/or refuse particular cards, accounts, and/or the like), and/or the like.

As further shown in FIG. 1C, and by reference number 145, the transaction platform may determine transaction terms for the user based on the validation of the transaction information (e.g., the account information associated with the user, the stored-value card information associated with the user, the loyalty information associated with the user, and/or the like). In some implementations, the transaction platform may calculate a credit score for the user based on the transaction information, and may determine the transaction terms based on the credit score for the user. In some implementations, the transaction platform may provide the transaction information to a device associated with an entity (e.g., a bank, a credit union, a vehicle financing company, and/or the like) that is financing the transaction, and the device may calculate the credit score for the user and determine the transaction terms based on the credit score. In some implementations, the transaction terms may include information indicating a quantity of cash needed for a down payment, a rate of interest for a loan, a term (e.g., in months, years, and/or the like) for a loan, and/or the like. For example, the transaction terms may indicate that the user is required to put $0 down for a down payment for the transaction, the term for the transaction is sixty (60) months, and the rate of interest for the transaction is 2.5%.

As further shown in FIG. 1C, and by reference number 150, the transaction platform may provide the transaction terms to the client device, and the client device may provide, for display to the user, information indicating the transaction terms. For example, the client device may provide, for display to the user, information indicating that the user has been approved or prequalified for the transaction at $0 cash down for 60 months at an annual percentage rate (APR) of 2.5%. In some implementations, the user, via the client device, may accept one or more of the transaction terms, reject one or more the transaction terms, and/or the like, and may provide information indicating the acceptance and/or the rejection of the one or more transaction terms to the transaction platform.

With reference to FIG. 1D, now assume that the user is not associated with stored-value cards and loyalty credits. As shown in FIG. 1D, and by reference number 155, the user may utilize the client device to request a transaction, and the client device may provide the request for the transaction to the transaction platform. For example, the user may request a vehicle loan to purchase the same new car from the car dealer. The transaction platform may receive the request for the transaction. In some implementations, the request may include information associated with the new car, information associated with accounts of the user (e.g., bank accounts, credit card accounts, debit card accounts, and/or the like), and/or the like. In some implementations, the transaction platform may receive the information associated with accounts of the user prior to generation of the request for the transaction.

As further shown in FIG. 1D, and by reference number 160, the transaction platform may request transaction information from the client device. In some implementations, the transaction platform may request transaction information that was not provided via the request for the transaction. For example, the transaction platform may request account information associated with the user, stored-value card information associated with the user, loyalty information associated with the user, and/or the like. The user may indicate (e.g., via inputting information) that the user wishes to utilize a particular account (e.g., Account 1 with $2,000 of cash available) for the new car loan. The user may also indicate that the user is not associated with stored-value cards and loyalty credits.

As further shown in FIG. 1D, and by reference number 165, the user may cause the client device to provide the transaction information (e.g., $2,000 cash from the particular account, $0 from stored-value cards, and $0 from loyalty programs) to the transaction platform. The transaction platform may receive the transaction information. In some implementations, rather than requesting the transaction information, the transaction platform may automatically select one or more accounts of the user that will provide the most value for the user (e.g., that will ensure that the user receives the best terms for the new car loan).

As shown in FIG. 1E, the transaction platform may validate the transaction information (e.g., the account information associated with the user). In some implementations, the transaction platform may validate the quantities of cash in the accounts (e.g., Account 1) of the user by querying devices associated with the accounts (e.g., devices associated with banks, credit card companies, debit card companies, and/or the like) of the user, and verifying that the quantities of cash in the accounts are correct.

As further shown in FIG. 1E, the transaction platform may determine transaction terms for the user based on the validation of the transaction information (e.g., the account information associated with the user). In some implementations, the transaction platform may calculate a credit score for the user based on the transaction information, and may determine the transaction terms based on the credit score for the user. In this example, the transaction terms may indicate that the user is required to put $1,500 down for a down payment for the transaction, the term for the transaction is sixty (60) months, and the rate of interest for the transaction is 4.5%. Thus, since the user is not associated with stored-value cards and loyalty credits, the transaction terms are worse for the user than as described above in connection with FIGS. 1A-1C (e.g., where the user is associated with stored-value cards and loyalty credits).

As further shown in FIG. 1E, and by reference number 170, the transaction platform may provide the transaction terms to the client device, and the client device may provide for display to the user information indicating the transaction terms. For example, the client device may provide for display to the user information indicating that the user has been approved or prequalified for the transaction at $1,500 cash down for 60 months at an APR of 4.5%.

With reference to FIGS. 1F-1H, now assume that the user is already prequalified for a transaction, and that the user wishes to utilize stored-value cards and/or loyalty credits to satisfy one or more of the transaction terms (e.g., a down payment, closing costs, processing fees, tax fees, and/or the like). As shown in FIG. 1F, and by reference number 175, the transaction platform may provide transaction terms to the client device. For example, the transaction terms may indicate that the user is required to pay a $4,000 down payment for the transaction. The client device may receive the transaction terms, and may provide the transaction terms (e.g., information indicating the down payment of $4,000) for display to the user. In some implementations, the transaction platform may provide a query, to the user (e.g., via the client device), inquiring whether the user wishes to use loyalty credits towards the down payment. In such implementations, the user may utilize the client device to indicate that the user wishes to use loyalty credits associated with one or more loyalty cards (e.g., a particular loyalty card associated with card number xxxx-xxxx-xxxx) towards the down payment.

As further shown in FIG. 1F, and by reference number 180, the user may cause the client device to provide card information to the transaction platform, and the transaction platform may receive the card information. In some implementations, the card information may include information indicating the card number for the particular loyalty card (e.g., xxxx-xxxx-xxxx), an expiration date for the particular loyalty card (e.g., 1/2020), a card verification value (CVV) code for the particular loyalty card, and/or the like.

As shown in FIG. 1G, and in some implementations, the transaction platform may provide a query, to the user (e.g., via the client device), inquiring whether the user wishes to use stored-value cards towards the down payment. In such implementations, the user may utilize the client device to indicate that the user wishes to use stored-value cards (e.g., a particular stored-value card associated with card number xxxx-xxxx-xxxx) towards the down payment. As further shown in FIG. 1G, and by reference number 185, the user may cause the client device to provide stored-value card information to the transaction platform, and the transaction platform may receive the stored-value card information. In some implementations, the stored-value card information may include information indicating the card number for the particular stored-value card (e.g., xxxx-xxxx-xxxx), a card name (e.g., ABC Card) for the particular stored-value card, and/or the like.

In some implementations, the transaction platform may determine and validate a quantity of loyalty credits on the particular loyalty card (e.g., card number xxxx-xxxx-xxxx) of the user by querying a device associated with the particular loyalty card, and determining the quantity of loyalty credits on the particular loyalty card. In some implementations, the transaction platform may determine and validate a quantity of cash on the particular stored-value card (e.g., ABC Card) of the user by querying a device associated with the particular stored-value card, and determining the quantity of cash on the particular stored-value card.

As shown in FIG. 1H, and in some implementations, the transaction platform may provide information indicating the quantity of loyalty credits on the particular loyalty card and the quantity of cash on the particular stored-value card to the client device. The client device may provide, for display to the user, the information indicating the quantity of loyalty credits on the particular loyalty card and the quantity of cash on the particular stored-value card. As further shown in FIG. 1H, the client device may enable the user to indicate how many loyalty credits on the particular loyalty card to apply to the down payment for the transaction, and an amount of the quantity of cash on the particular stored-value card to apply to the down payment. For example, the user may indicate that 2000 loyalty credits from the particular loyalty card are to be applied to the down payment, and that $1,000 of cash on the particular stored-value card is to be applied to the down payment.

As further shown in FIG. 1H, and by reference number 190, the client device may provide, to the transaction platform, information indicating how many loyalty credits (e.g., 2000) on the particular loyalty card to apply to the down payment, and the amount (e.g., $1,000) of the quantity of cash on the particular stored-value card to apply to the down payment. The transaction platform may receive the information indicating how many loyalty credits on the particular loyalty card to apply to the down payment, and the amount of the quantity of cash on the particular stored-value card to apply to the down payment. The transaction platform may modify the transaction terms based on such information. For example, the transaction platform may modify the transaction terms to indicate that a new down payment is $2,000 in cash (e.g., rather than $4,000) since the loyalty credits (e.g., 2000) on the particular loyalty card covered $1,000 of the down payment and the amount (e.g., $1,000) on the particular stored-value card covered another $1,000 of the down payment. As further shown in FIG. 1G, and by reference number 195, the transaction platform may provide modified transaction terms (e.g., indicating the $2,000 down payment) to the client device. The client device may provide the modified transaction terms for display to the user.

Although FIGS. 1A-1H discuss utilizing loyalty credits and stored-value cards in the transaction process, in some implementations, other types of currencies may be used in the transaction process, such as blockchain-based currencies or cryptocurrencies (e.g., Bitcoin, Ethereum, Litecoin, Ripple, Dogecoin, Coinye, and/or the like).

In this way, several different stages of the transaction process are automated using a model, which may remove human subjectivity and waste from the process, and which may improve speed and efficiency of the process and conserve computing resources (e.g., processors, memory, and/or the like). Furthermore, implementations described herein use a computerized process to perform tasks or roles that were not previously performed or were previously performed using subjective human intuition or input. For example, the transaction platform utilizes machine learning to determine transaction terms for a transaction based on loyalty credits and stored-value cards that were previously not utilized to determine transaction terms. The transaction platform also enables transaction terms to be satisfied with loyalty credits and stored-value cards in a manner that was not previously utilized to satisfy transaction terms. Finally, the transaction platform conserves computing resources (e.g., processors, memory, and/or the like) that would otherwise be wasted in determining and validating loyalty credits and stored-value cards.

As indicated above, FIGS. 1A-1H are provided merely as examples. Other examples are possible and may differ from what was described with regard to FIGS. 1A-1H.

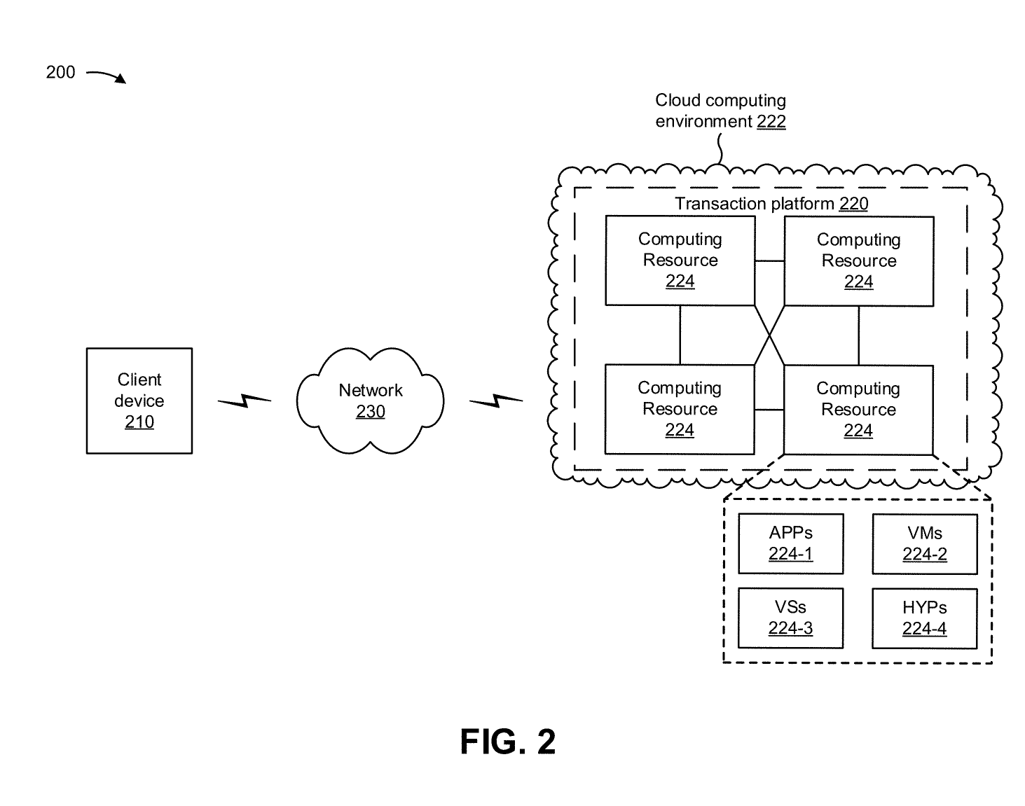

FIG. 2 is a diagram of an example environment 200 in which systems and/or methods, described herein, may be implemented. As shown in FIG. 2, environment 200 may include a client device 210, a transaction platform 220, and a network 230. Devices of environment 200 may interconnect via wired connections, wireless connections, or a combination of wired and wireless connections.

Client device 210 includes one or more devices capable of receiving, generating, storing, processing, and/or providing information, such as information described herein. For example, client device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, client device 210 may receive information from and/or transmit information to transaction platform 220.

Transaction platform 220 includes one or more devices that utilize machine learning to generate recommendations for a transaction based on loyalty credits and stored-value cards. In some implementations, transaction platform 220 may be designed to be modular such that certain software components may be swapped in or out depending on a particular need. As such, transaction platform 220 may be easily and/or quickly reconfigured for different uses. In some implementations, transaction platform 220 may receive information from and/or transmit information to one or more client devices 210.

In some implementations, as shown, transaction platform 220 may be hosted in a cloud computing environment 222. Notably, while implementations described herein describe transaction platform 220 as being hosted in cloud computing environment 222, in some implementations, transaction platform 220 may not be cloud-based (i.e., may be implemented outside of a cloud computing environment) or may be partially cloud-based.

Cloud computing environment 222 includes an environment that hosts transaction platform 220. Cloud computing environment 222 may provide computation, software, data access, storage, etc. services that do not require end-user knowledge of a physical location and configuration of system(s) and/or device(s) that hosts transaction platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host transaction platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by client device 210. Application 224-1 may eliminate a need to install and execute the software applications on client device 210. For example, application 224-1 may include software associated with transaction platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., an operator of transaction platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

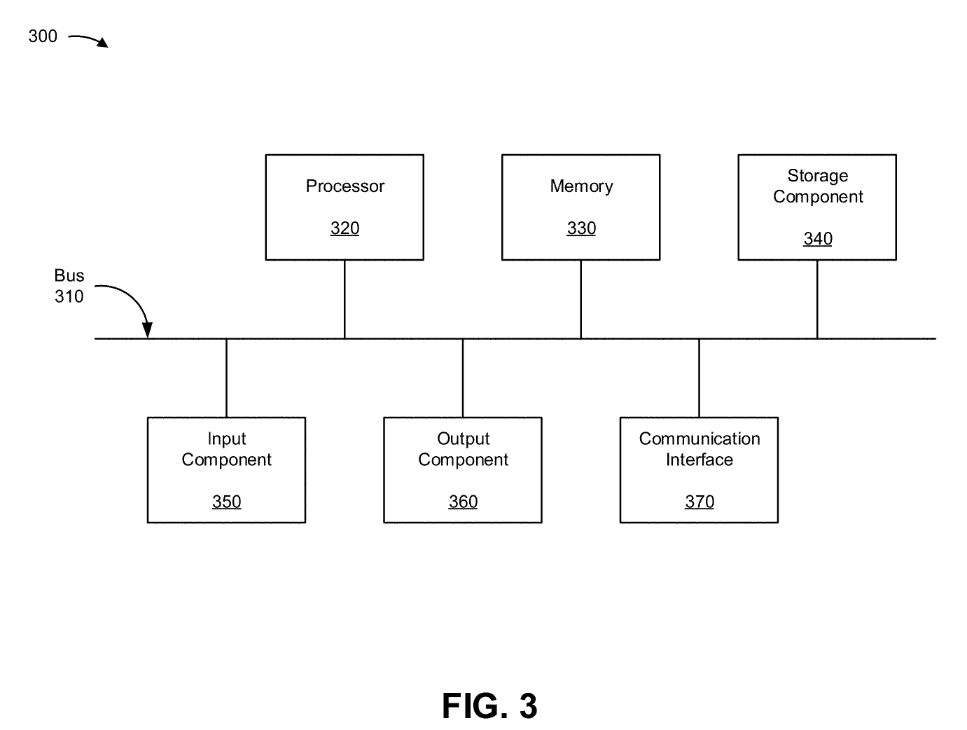

FIG. 3 is a diagram of example components of a device 300. Device 300 may correspond to client device 210, transaction platform 220, and/or computing resource 224. In some implementations, client device 210, transaction platform 220, and/or computing resource 224 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

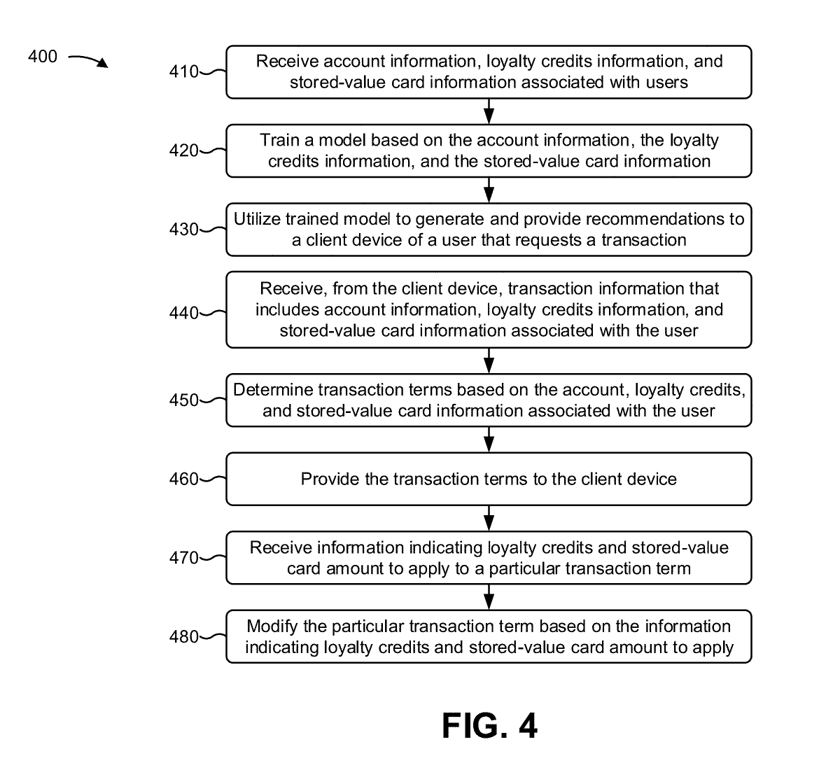

FIG. 4 is a flow chart of an example process 400 for utilizing machine learning to generate recommendations for a transaction based on loyalty credits and stored-value cards. In some implementations, one or more process blocks of FIG. 4 may be performed by transaction platform 220. In some implementations, one or more process blocks of FIG. 4 may be performed by another device or a group of devices separate from or including transaction platform 220, such as client device 210.

As shown in FIG. 4, process 400 may include receiving account information, loyalty credits information, and stored-value card information associated with users (block 410). For example, transaction platform 220 may receive account information, loyalty credits information, and stored-value card information associated with users. In some implementations, transaction platform 220 may receive prior transaction information of other users. In some implementations, the prior transaction information may be received from other users of transaction platform 220, from third party resources (e.g., devices associated with banks, credit unions, financing companies, sellers of products, sellers of services, and/or the like), and/or the like.

In some implementations, the prior transaction information may include information associated with prior transactions of other users, such as applications for loans (e.g., vehicle loans, mortgage loans, payday loans, appliance loans, home equity loans, student loans, personal loans, small business loans, and/or the like) by the other users, purchases of products, services, products and services, and/or the like by the other users, and/or the like. In some implementations, the prior transaction information may include account information associated with accounts of the other users or utilized by the other users for the prior transactions, such as bank accounts, credit card accounts, debit card accounts, and/or the like of the other users. In some implementations, the prior transaction information may include loyalty credits information associated with loyalty credits of the other users or utilized by the other users for the prior transactions. In some implementations, the prior transaction information may include stored-value card information associated with stored-value cards of the other users or utilized by the other users for the prior transactions.

In some implementations, transaction platform 220 may store the prior transaction information in a data structure, such as a database, a table, a linked-list, a tree, and/or the like. In some implementations, the data structure may be provided in a memory associated with transaction platform 220. Transaction platform 220 may store the prior transaction information so that transaction platform 220 may perform further processing on the prior transaction information. In some implementations, transaction platform 220 may provide security features so that prior transaction information is maintained in confidence. For example, transaction platform 220 may apply one or more types of encryption, tokenization, authentication, and/or other security techniques to protect the prior transaction information while the prior transaction information is stored (e.g., in a database) and/or when the prior transaction information is transmitted (e.g., over a network).

As further shown in FIG. 4, process 400 may include training a model based on the account information, the loyalty credits information, and the stored-value card information (block 420). For example, transaction platform 220 may train a model based on the account information, the loyalty credits information, and the stored-value card information. In some implementations, transaction platform 220 may train the model to determine patterns associated with prior transactions, stored-value cards, and loyalty credits associated with other users. In some implementations, the model may include a collaborative filtering model, an artificial intelligence model, a machine learning model, a naïve Bayes biased classifier model, a deep learning neural network model, a neural network model, a support vector machine model, and/or the like.

In some implementations, transaction platform 220 may train the model by using a machine learning algorithm or a similar technique. In some implementations, transaction platform 220 may train the model using a training data set of prior transactions (e.g., account information, loyalty credits information, and/or stored-value card information) to determine patterns associated with the prior transactions. For example, transaction platform 220 may train the model using a supervised learning method (e.g., a gradient descent, a stochastic gradient descent, and/or the like). In some implementations, transaction platform 220 may train the model using a test data set that is independent of the training data set, but that follows a same probability distribution as the training data set. In some implementations, transaction platform 220 may train the model using a validation data set.

In some implementations, transaction platform 220 may utilize a collaborative filtering model. In some implementations, the collaborative filtering model may filter for information or patterns using techniques involving collaboration among multiple agents, viewpoints, data sources, and/or the like. For example, the collaborative filtering model may make automatic predictions (e.g., filtering) about interests of a user by collecting preferences or taste information from many users (e.g., collaborating). In this case, the collaborative filtering model may determine that if a first user has a preference that is the same as a preference of a second user with respect to a particular choice (e.g., to select a particular type of vehicle for purchase), then the first user is more likely to have a preference that is the same as a preference of a second user with respect to a different particular choice (e.g., to use a particular stored-value card to be applied to a down payment for a vehicle loan).

As further shown in FIG. 4, process 400 may include utilizing the trained model to generate and provide recommendations to a client device of a user that requests a transaction (block 430). For example, transaction platform 220 may utilize the trained model to generate and provide recommendations to client device 210 of a user that requests a transaction. In some implementations, the user may utilize client device 210 to request a transaction, and client device 210 may provide the request for the transaction to transaction platform 220. Transaction platform 220 may receive the request for the transaction. In some implementations, the request may include information associated with a product and/or a service, information associated with accounts of the user (e.g., bank accounts, credit card accounts, debit card accounts, and/or the like), information associated with loyalty credits of the user, information associated with stored-value cards of the user, and/or the like. In some implementations, transaction platform 220 may receive the information associated with accounts of the user, the information associated with loyalty credits of the user, and the information associated with stored-value cards of the user prior to generation of the request for the transaction.

In some implementations, transaction platform 220 may utilize the trained model to generate recommendations for the transaction. In some implementations, transaction platform 220 may utilize the information included the request with the trained model in order to determine similarities between the prior transaction information and the request for the transaction, and to generate the recommendations based on the similarities. Transaction platform 220 may provide the recommendations to client device 210, and client device 210 may provide the recommendations for display to the user.

In some implementations, transaction platform 220 may utilize a collaborative filtering model with the prior transaction information to automatically predict interests of a user based on preferences of many users (e.g., the prior transaction information). In some implementations, transaction platform 220 may develop the collaborative filtering model using different data mining and machine learning techniques to predict a user's rating of unrated information. The collaborative filtering model may include, for example, a Bayesian network model, a clustering model, a latent semantic model such as singular value decomposition model, a probabilistic latent semantic analysis model, a multiple multiplicative factor model, latent Dirichlet allocation model, Markov decision process model, and/or the like.

As further shown in FIG. 4, process 400 may include receiving, from the client device, transaction information that includes account information, loyalty credits information, and stored-value information associated with the user (block 440). For example, transaction platform 220 may receive, from client device 210, transaction information that includes account information, loyalty credits information, and stored-value information associated with the user. In some implementations, transaction platform 220 may request transaction information from the client device. In some implementations, transaction platform 220 may request transaction information that was not provided via the request for the transaction. For example, transaction platform 220 may request account information associated with the user, stored-value card information associated with the user, loyalty information associated with the user, and/or the like.

In some implementations, the account information may include information associated with accounts to be utilized by the user for the transaction, such as bank accounts, credit card accounts, debit card accounts, and/or the like of the user. In some implementations, the stored-value card information may include information associated with stored-value cards to be utilized by the user for the transaction. In some implementations, the loyalty information may include information associated with loyalty credits to be utilized by the user for the transaction.

In some implementations, the user may cause client device 210 to provide the transaction information to transaction platform 220. In some implementations, the transaction information may be provided based on one or more of the recommendations or none of the recommendations. Transaction platform 220 may receive the transaction information.

In some implementations, rather than requesting the transaction information, transaction platform 220 may automatically select one or more accounts of the user, one or more loyalty credits of the user, and/or one or more stored-value cards of the user that will provide the most value for the user (e.g., that will ensure that the user receives the best terms for the new car loan). In some implementations, transaction platform 220 may determine a best mix of accounts, loyalty credits, and stored-value cards to provide a greatest credit score for the user. In some implementations, transaction platform 220 may determine a best mix of loyalty credits and stored-value cards, when combined with all accounts associated with the user, to provide a greatest credit score for the user.

As further shown in FIG. 4, process 400 may include determining transaction terms based on the account information, the loyalty credits information, and stored-value information associated with the user (block 450). For example, transaction platform 220 may determine transaction terms based on the account information, the loyalty credits information, and stored-value information associated with the user. In some implementations, transaction platform 220 may validate the transaction information (e.g., the account information associated with the user, the stored-value card information associated with the user, the loyalty information associated with the user, and/or the like). In some implementations, transaction platform 220 may validate the quantities of cash in the accounts of the user by querying devices associated with the accounts of the user, and verifying that the quantities of cash in the accounts are correct. In some implementations, transaction platform 220 may validate the quantities of cash on the stored-value cards of the user by querying devices associated with the stored-value cards of the user, and verifying that the quantities of cash on the stored-value cards are correct. In some implementations, transaction platform 220 may validate cash values of the loyalty credits of the user by querying devices associated with the loyalty credits of the user, and verifying that the cash values of the loyalty credits are correct.

In some implementations, transaction platform 220 may determine transaction terms for the user based on the validation of the transaction information (e.g., the account information associated with the user, the stored-value card information associated with the user, the loyalty information associated with the user, and/or the like). In some implementations, transaction platform 220 may calculate a credit score for the user based on the transaction information, and may determine the transaction terms based on the credit score for the user. In some implementations, transaction platform 220 may provide the transaction information to a device associated with an entity (e.g., a bank, a credit union, a vehicle financing company, and/or the like) that is financing the transaction, and the device may calculate the credit score for the user and determine the transaction terms based on the credit score. In some implementations, the transaction terms may include information indicating a quantity of cash needed for a down payment, a rate of interest for a loan, a term for a loan, and/or the like.

As further shown in FIG. 4, process 400 may include providing the transaction terms to the client device (block 460). For example, transaction platform 220 may provide the transaction terms to client device 210. In some implementations, client device 210 may provide, for display to the user, information indicating the transaction terms. For example, client device 210 may provide, for display to the user, information indicating that the user has been approved or prequalified for the transaction at $0 cash down for 60 months at an annual percentage rate (APR) of 2.5%, as described above in connection with FIG. 1C.

As further shown in FIG. 4, process 400 may include receiving information indicating loyalty credits and a stored-value card amount to apply to a particular transaction term (block 470). For example, transaction platform 220 may receive information indicating loyalty credits and a stored-value card amount to apply to a particular transaction term. In some implementations, transaction platform 220 may provide a query, to client device 210, inquiring whether the user wishes to use loyalty credits towards a particular transaction term (e.g., a down payment). The user may cause client device 210 to provide card information to transaction platform 220, and transaction platform 220 may receive the card information. In some implementations, the card information may include information indicating a card number for a particular loyalty card.

In some implementations, transaction platform 220 may provide a query, to client device 210, inquiring whether the user wishes to use stored-value cards towards the down payment. The user may cause client device 210 to provide stored-value card information to transaction platform 220, and transaction platform 220 may receive the stored-value card information. In some implementations, the stored-value card information may include information indicating a card number for a particular stored-value card.

In some implementations, transaction platform 220 may determine and validate a quantity of loyalty credits on the particular loyalty card, and may determine and validate a quantity of cash on the particular stored-value card. In some implementations, transaction platform 220 may provide information indicating the quantity of loyalty credits on the particular loyalty card and the quantity of cash on the particular stored-value card to client device 210. Client device 210 may enable the user to indicate how many loyalty credits on the particular loyalty card to apply to the down payment for the transaction, and an amount of the quantity of cash on the particular stored-value card to apply to the down payment. Client device 210 may provide, to transaction platform 220, information indicating how many loyalty credits on the particular loyalty card to apply to the down payment, and the amount of the quantity of cash on the particular stored-value card to apply to the down payment. Transaction platform 220 may receive the information indicating how many loyalty credits on the particular loyalty card to apply to the down payment, and the amount of the quantity of cash on the particular stored-value card to apply to the down payment.

As further shown in FIG. 4, process 400 may include modifying the particular transaction term based on the information indicating the loyalty credits and the stored-value card amount to apply to the particular transaction term (block 480). For example, transaction platform 220 may modify the particular transaction term based on the information indicating the loyalty credits and the stored-value card amount to apply to the particular transaction term. In some implementations, transaction platform 220 may modify the transaction terms to indicate a new down payment since the loyalty credits on the particular loyalty card are applied some of the down payment and the amount on the particular stored-value card is applied some of the down payment. In some implementations, transaction platform 220 may provide modified transaction terms to client device 210, and client device 210 may provide the modified transaction terms for display to the user.

In some implementations, transaction platform 220 may automatically complete the transaction for the user when the user accepts the terms of the transaction. For example, if the user purchased a product (e.g., a vehicle, an appliance, and/or the like), transaction platform 220 may automatically order the product from a merchant, may pay for the product, and may cause the product to be shipped to the user. In another example, if the user purchased a service (e.g., an education loan), transaction platform 220 may automatically make arrangements with the educational institution to pay tuition when the tuition is due (e.g., each semester), to pay for room and board, and/or the like.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Some implementations described herein provide a transaction platform that utilizes machine learning to generate recommendations and better terms for a transaction based on loyalty credits and stored-value cards. For example, the transaction platform may train a model based on information that relates to bank accounts associated with users, information that relates to loyalty credits associated with the users, and information that relates to stored-value cards associated with the users. The transaction platform may utilize the trained model to generate recommendations associated with a transaction requested by a consumer, and may provide the recommendations to the consumer. The transaction platform may receive account information associated with a bank account of the consumer, loyalty credits information identifying loyalty credits associated with the consumer, and stored-value card information identifying a stored-value card associated with the consumer. The transaction platform may determine transaction terms for the transaction based on the account information, the loyalty credits information, and the stored-value card information, and may provide information identifying the transaction terms to the consumer.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A device, comprising:
one or more memories;
a communication interface to communicate with a first group of servers, a second group of servers, and a third group of servers;
a machine learning component; and
one or more processors, communicatively coupled to the one or more memories, to:
receive, via the communication interface, a first set of information from the first group of servers,
the first set of information relating to financial accounts associated with a plurality of users,
the first set of information relating to prior transaction information associated with the plurality of users;
receive, via the communication interface, a second set of information from the second group of servers,
the second set of information relating to loyalty credits associated with the plurality of users,
the second set of information relating to prior transaction information associated with the plurality of users;
receive, via the communication interface, a third set of information from the third group of servers,
the third set of information relating to stored-value cards associated with the plurality of users,
the third set of information relating to prior transaction information associated with the plurality of users;
store the prior transaction information associated with the first set of information, the second set of information, and the third set of information in a data structure for further processing;
apply one or more security techniques to protect the prior transaction information while the prior transaction information is being stored;
train a model, via the machine learning component, based on the first set of information, the second set of information, and the third set of information,
the model being trained to determine patterns associated with respective prior transaction information related to the first set of information, the second set of information, and the third set of information,
the model being a collaborative filtering model filtering the patterns associated with the prior transaction information associated with the plurality of users;
receive, from a client device associated with a user, a request for a transaction;
utilize the trained model to generate one or more recommendations associated with the transaction;
provide, to the client device, the one or more recommendations and a request for transaction information associated with the user;
receive, from the client device, the transaction information based on the request for the transaction information,
the transaction information including:
account information associated with a financial account of the user, and
at least one of;
loyalty credits information identifying loyalty credits associated with the user, or
stored-value card information identifying a stored-value card associated with the user;
determine transaction terms for the transaction based on validation of the transaction information associated with the user;
provide information identifying the transaction terms to the client device;
receive information indicating at least one of a quantity of the loyalty credits or an amount of the stored-value card to apply to a particular term of the transaction terms;
modify the particular term based on the information indicating the at least one of the quantity of the loyalty credits or the amount of the stored-value card to apply to the particular term; and
provide the modified particular term to the client device.

2. The device of claim 1, where the one or more processors are further to:
receive an acceptance or a rejection of the transaction terms from the client device.

3. (canceled)

4. The device of claim 1, where the one or more processors are further to:
receive an acceptance or a rejection of the particular term from the client device.

5. The device of claim 1, where the particular term includes one of:
a down payment for the transaction,
an insurance fee for the transaction,
a tax fee for the transaction, or
a closing fee for the transaction.

6. The device of claim 1, where the one or more recommendations includes one or more of:
a recommendation for a particular product,
a recommendation for a particular service,
a recommendation for a particular stored-value card, or
a recommendation for particular loyalty credits.

7. The device of claim 1, where the transaction includes at least one of:
a vehicle loan,
a mortgage loan,
a payday loan,
an appliance loan,
a home equity loan,
a student loan,
a personal loan, or
a small business loan.

8. A non-transitory computer-readable medium storing instructions, the instructions comprising:
one or more instructions that, when executed by one or more processors, cause the one or more processors to:
receive a first set of information from a first group of servers,
the first set of information relating to financial accounts associated with a plurality of users,
the first set of information relating to prior transaction information associated with the plurality of users;
receive a second set of information from a second group of servers,
the second set of information relating to loyalty credits associated with the plurality of users,
the second set of information relating to prior transaction information associated with the plurality of users;
receive a third set of information from a third group of servers,
the third set of information relating to stored-value cards associated with the plurality of users,
the third set of information relating to prior transaction information associated with the plurality of users;
store the prior transaction information associated with the first set of information, the second set of information, and the third set of information in a data structure for further processing;
apply one or more security techniques to protect the prior transaction information while the prior transaction information is being stored;
train, via a machine learning component, a model based on the first set of information, the second set of information, and the third set of information,
the model being trained to determine patterns associated with respective prior transaction information related to the first set of information, the second set of information, and the third set of information,
the model being a collaborative filtering model filtering the patterns associated with the prior transaction information associated with the plurality of users;
receive, from a client device associated with a user, a request for a transaction;
utilize the trained model to generate one or more recommendations associated with the transaction;
provide, to the client device, the one or more recommendations and a request for transaction information associated with the user;
receive, from the client device, the transaction information based on the one or more recommendations and based on the request for the transaction information,
the transaction information including:
account information associated with a financial account of the user, and
loyalty credits information identifying loyalty credits associated with the user;
determine transaction terms for the transaction based on validation of the transaction information associated with the user;
provide information identifying the transaction terms to the client device;
receive information indicating at least one of a quantity of the loyalty credits or an amount of the stored-value card to apply to a particular term of the transaction terms;
modify the particular term based on the information indicating the at least one of the quantity of the loyalty credits or the amount of the stored-value card to apply to the particular term; and
provide the modified particular term to the client device.

9. The non-transitory computer-readable medium of claim 8, where the instructions further comprise:
one or more instructions that, when executed by the one or more processors, cause the one or more processors to:
receive, from the client device, stored-value card information identifying a stored-value card associated with the user;
modify the transaction terms, based on the stored-value card information, and to generate modified transaction terms; and
provide the modified transaction terms to the client device.

10. (canceled)

11. The non-transitory computer-readable medium of claim 8, where the instructions further comprise:
one or more instructions that, when executed by the one or more processors, cause the one or more processors to:
receive information indicating an amount of a stored-value card to apply to the modified particular term;
further modify the modified particular term based on the information indicating the amount of the stored-value card to apply to the modified particular term; and
provide the further modified particular term to the client device.

12. The non-transitory computer-readable medium of claim 8, where the particular term includes one of:
a down payment for the transaction,
an insurance fee for the transaction,
a tax fee for the transaction, or
a closing fee for the transaction.

13. The non-transitory computer-readable medium of claim 8, where the one or more recommendations includes one or more of:
a recommendation for a particular product,
a recommendation for a particular service,
a recommendation for a particular stored-value card, or
a recommendation for particular loyalty credits.

14. The non-transitory computer-readable medium of claim 8, where the instructions further comprise:
one or more instructions that, when executed by the one or more processors, cause the one or more processors to:
receive an acceptance of the transaction terms from the client device; and
complete the transaction based on the acceptance of the transaction terms.

15. A method, comprising:
receiving, by a device, a first set of information from a first group of servers,
the first set of information relating to financial accounts associated with a plurality of users,
the first set of information relating to prior transaction information associated with the plurality of users;
receiving, by the device, a second set of information from a second group of servers,
the second set of information relating to loyalty credits associated with the plurality of users,
the second set of information relating to prior transaction information associated with the plurality of users;
receiving, by the device, a third set of information from a third group of servers,
the third set of information relating to stored-value cards associated with the plurality of users,
the third set of information relating to prior transaction information associated with the plurality of users;
storing, by the device, the prior transaction information associated with the first set of information, the second set of information, and the third set of information in a data structure for further processing;
applying, by the device, one or more security techniques to protect the prior transaction information while the prior transaction information is being stored;
training, by a machine learning component of the device, a model based on the first set of information, the second set of information, and the third set of information,
the model being trained to determine patterns associated with respective prior transaction information related to the first set of information, the second set of information, and the third set of information,
the model being a collaborative filtering model for filtering the patterns associated with the prior transaction information associated with the plurality of users;
receiving, by the device and from a client device associated with a user, a request for a transaction;
utilizing, by the device, the trained model to generate one or more recommendations associated with the transaction and the user;
providing, by the device and to the client device, the one or more recommendations;
obtaining, by the device and based on the one or more recommendations, account information associated with a financial account of the user;
obtaining, by the device and based on the one or more recommendations, loyalty credits information identifying loyalty credits associated with the user;
obtaining, by the device and based on the one or more recommendations, stored-value card information identifying a stored-value card associated with the user;
determining, by the device, transaction terms for the transaction based on validation of the transaction information associated with the user;
providing, by the device, information identifying the transaction terms to the client device;
receiving, by the device, information indicating at least one of a quantity of the loyalty credits or an amount of the stored-value card to apply to a particular term of the transaction terms;
modifying, by the device, the particular term based on the information indicating the at least one of the quantity of the loyalty credits or the amount of the stored-value card to apply to the particular term; and
providing, by the device, the modified particular term to the client device.

16-17. (canceled)

18. The method of claim 15, where the one or more recommendations includes one or more of:
a recommendation for a particular product,
a recommendation for a particular service,
a recommendation for a particular stored-value card, or
a recommendation for particular loyalty credits.

19. The method of claim 15, where the transaction includes at least one of:
a vehicle loan,
a mortgage loan,
a payday loan,
an appliance loan,
a home equity loan,
a student loan,
a personal loan, or
a small business loan.

20. The method of claim 15, further comprising:
receiving an acceptance of the transaction terms from the client device; and
completing the transaction based on the acceptance of the transaction terms.

21. The device of claim 1, where the one or more processors are further to:
process the prior transaction information utilizing natural language processing.

22. The non-transitory computer-readable medium of claim 8, where the instructions further comprise:
one or more instructions that, when executed by the one or more processors, cause the one or more processors to:
process the prior transaction information utilizing natural language processing.

23. The method of claim 15, further comprising:
processing the prior transaction information utilizing natural language processing.

24. The method of claim 15, further comprising:
calculating a credit score for the user based on the transaction information; and
where determining the transaction terms of the transaction comprises:
determining the transaction terms of the transaction based on the credit score.
